(19) United States
(12) Patent Application Publication
(10) Pub. No.: US 2010/0261457 A1
(43) Pub. Date: Oct. 14, 2010

(54) Broadcasting pre-recorded content directly into subscribers' cellular voice-mail box

(76) Inventor: Chris Cassapakis, Escondido, CA (US)

Correspondence Address: Chris Cassapakis, 1408 Paint Mountain Rd., Escondido, CA, 92029, US

(21) Appl. No.: 12/386,065

(22) Filed: Apr. 14, 2009

(51) Int. Cl. H04M 11/10

(52) U.S. Cl. 455/413

(57) ABSTRACT

A broadcasting approach wherein pre-recorded content is directly transferred to voice-mail box of subscribers. The content distributed as messages to subscribers are segregated by category, and subscribers can select the category of content they want. Content can be messages in audio form or video form, etc. The audio messages are in MP3 or similar format. The video messages are in AVI, MPEG or similar formats. The content is stored in a content repository. A subscriber database is maintained with cellular phone numbers and the types of content preferred by subscribers. A mechanism that matches the type of content that is appropriate for a subscriber with new content is used to directly select content that needs to be delivered. The present invention supports a process that delivers the content directly into the subscriber's voice mail box.

### CROSS REFERENCES TO RELATED APPLICATIONS

### BACKGROUND

1. Technical Field

The present invention relates generally to broadcasting messages and more specifically to broadcasting the same message to several different subscribers using a voice-mail system.

2. Related Art

Voice-mail systems are becoming ubiquitous. People use voice-mail for receiving messages from callers on their cellular phones/mobile phones and sometimes for phones used in offices and residences. On some voice-mail systems, users use their own welcome messages for their voice mail boxes. Subscribers are typically assigned a voice-mailbox. In general, a caller is first connected to a mobile phone of the subscriber (the called party) by the cellular network, and then, if the called mobile phone is found to be busy, the caller is connected to a voice-mailbox associated with the subscriber (called party). Often, a caller wants to just leave a message for the recipient, without disturbing the recipient. It is not possible as most networks do not support any such feature. Thus, it is often not possible for a caller to silently leave a voice message to a recipient on the recipient's mobile phone.

Quite often a caller needs to communicate the same message to several recipients. The caller has to dial a phone number for each recipient and talk to the recipient in order to convey the message. In most cellular networks, there are no mechanisms available for a caller to call several different recipients and convey the same message, other than a conference call facility wherein all the recipients are required to be connected to the conference call facility in order to receive the message.

If a business/company has to broadcast the same message to several users, they use telemarketing services. An individual is assigned to dial several users, and he calls one user at a time and conveys a message, such as a marketing message. Telemarketing typically requires one or more individuals to call hundreds of mobile phone users and talk to those users in an unsolicited manner, often causing a disturbance, inconvenience or annoyance to those users.

Every day people use a lot of self-help services wherein they listen to lectures given by a self-help expert. Such lectures require the user to physically attend a lecture at a convention hall. Otherwise, the user can play a pre-recorded CD of the lecture in a CD player in his home or in an automobile, etc. Unfortunately, there are very few means by which such self-help lectures, or subsets thereof, can be provided to a user over his mobile phones. Some users of high-end mobile phones are able to receive some types of streaming media (such as MP3 based songs) from special servers, such as those used by Apple's iTunes servers.

Despite widespread usage of mobile phones and despite lowered costs of mobile devices, people have not been provided with effective message broadcasting technologies. People are, in recent times, being encouraged by operators of cellular networks to subscribe to new services such as MP3 downloads and mobile movies. Currently, news, entertainment, educational and/or public service type audible content can be searched and downloaded by users directly into their cellular devices.

Voice-mail can be received by users from callers who may have tried to get in touch with them when they were busy using the cellular device (such as on a phone call). It is currently possible for an individual caller to call a specific mobile phone number of a friend or colleague and leave a message for that individual recipient. Some networks allow an individual caller to call a centralized service, record a message for a friend, identify the friend's cellular phone number, and have the message delivered to that phone number. One drawback of this solution is that it is a one-to-one message delivery. Another disadvantage is that the message has to be recorded by the caller, i.e. a live person. Furthermore, if the caller has to communicate the same message to several potential recipients, the caller has to repeat the whole process and leave a message individually for each of the recipients. This is a tedious task and is also time consuming.

Further limitations and disadvantages of conventional and traditional approaches will become apparent to one of ordinary skill in the art through comparison of such systems with various aspects of the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a voice-mail based message broadcasting system that delivers content directly into a subscriber's voice mailbox.

FIG. 2 is a flow chart of an exemplary operation of the voice-mail based message broadcasting system.

FIG. 3 is a perspective block diagram of an exemplary voice-mail based broadcasting system built in accordance with the present invention that broadcasts messages, such as audio and video messages, to a plurality of subscribers via their voice-mailbox.

FIG. 4 is a flow chart of an exemplary operation of the voice-mail based broadcasting system that is capable of distributing a message to a plurality of subscribers on their corresponding mobile devices.

### DETAILED DESCRIPTION OF THE DRAWINGS

The present invention provides an elegant means of broadcasting the same audio or video message to several recipients employing a voice-mail system. News, entertainment, educational and/or public service type audible content can be delivered directly into a subscriber's cellular voice-mail without having to set up an actual call and without having to disturb the subscriber.

The present invention provides a broadcasting approach wherein pre-recorded content is directly transferred to voice-mail box of subscribers. The content distributed as messages to subscribers are segregated by category, and subscribers can select the categories of content they want. Content can be messages in audio form or video form, etc. The audio messages are in MP3 or similar format. The video messages are in AVI, MPEG or similar formats. The content is stored in a content repository in the network. A subscriber database is also maintained in the network with cellular phone numbers and the types of content preferred by subscribers. A mechanism that matches the type of content that is appropriate for a subscriber with new content is used to directly select content that needs to be delivered. The present invention supports a process that delivers the content directly into the subscriber's voice mail box.

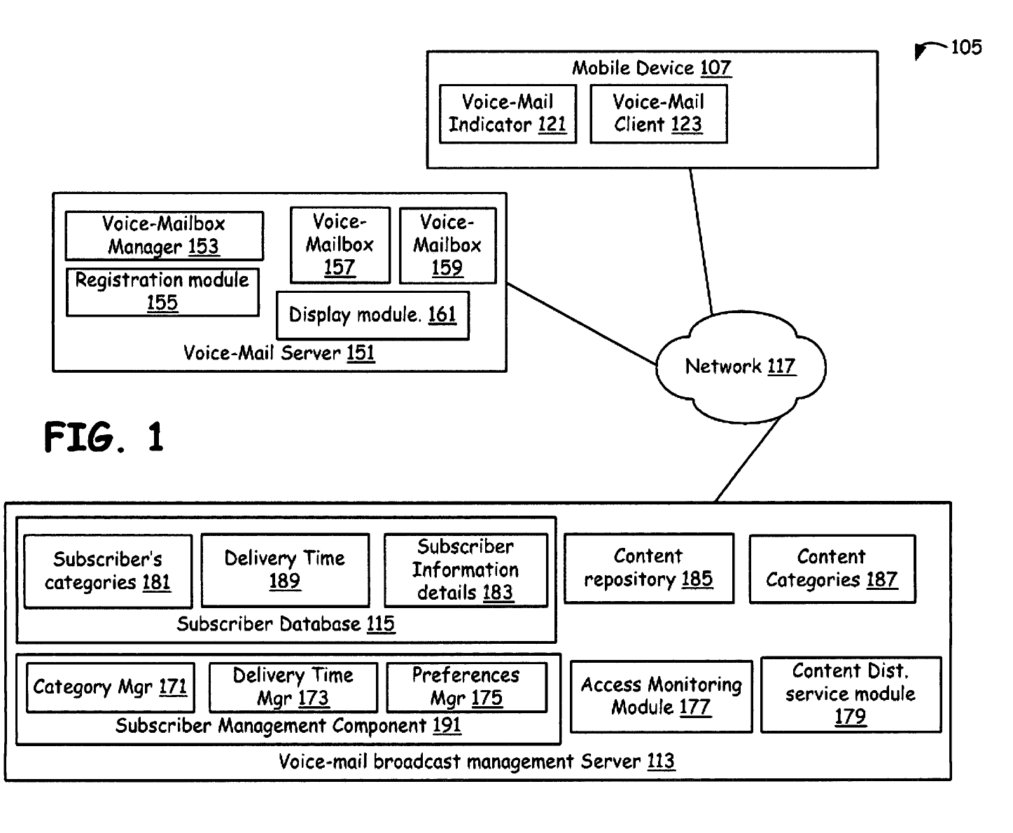

FIG. 1 is a perspective block diagram of a voice-mail based message broadcasting system 105 that delivers content directly into a subscriber's voice mailbox 157, 159. A subscriber can pre-select the category of content the subscriber would like to receive and also specifies a time window for delivery of messages upon registration with a voice-mail broadcast management server 113. When new content is made available, its content type is matched with the category of content for the subscribers. When a match is detected, that new content is provided to the subscriber during the requested delivery time window, employing the cellular phone number available from a subscriber database 115 in the voice-mail broadcast management server 113.

The content distributed as messages to subscribers are segregated by category. The audio messages are in MP3 or similar format. The video messages are in AVI, MPEG or similar formats. The content is stored in a content repository. A subscriber database is maintained with cellular phone numbers and the types of content preferred by subscribers. A mechanism that matches the type of content that is appropriate for a subscriber with new content is used to select content that needs to be delivered. The present invention supports a process that delivers the content directly into the subscriber's voice mail box.

The voice-mail server 151 comprises a voice-mailbox manager 153 that manages creating voicemail and accessing voicemail, etc., a registration module 155 that facilitates registration of new voice-mailboxes for subscribers, a display module 161 that displays available voicemail for a subscriber, and a plurality of voice-mailboxes 157, 159. When a user gets a new voicemail in his voice-mailbox, the voice-mail server 151 causes a voice-mail indicator 121 in the user's mobile device 107 to be set.

The voice-mail based message broadcasting system 105 comprises a voice-mail broadcast management server 113 communicatively coupled to a plurality of voice-mail boxes located at a voice-mail server 151. It also comprises a content repository 185 and the subscriber database 115. The voice-mail broadcast management server 113 provides efficient voice-mail distribution to more than one of the plurality of voice-mail boxes 157, 159 employing a content stored in the content repository 185. The voice-mail broadcast management server 113 broadcasts a pre-recorded message to the several (more than one) voice-mail boxes managed by the voice-mail server 151. The pre-recorded message is typically the content retrieved from the content repository 185. The voice-mail broadcast management server 113 tracks a user's access to the pre-recorded message from a corresponding one of the plurality of voice-mail boxes, such as the voice-mailbox 157, via a user's mobile device 107.

The voice-mail based message broadcasting system 105 also comprises an access monitoring module 177 that keeps track of access of audio and video messages by individual subscribers. It also comprises a content distribution service module 179 that manages interactions with the voice-mail server 151 for distributing content, such as audio messages, video messages etc. It also manages content life-cycle management, including creation, deletion, update of content, etc.

The voice-mail based message broadcasting system 105 also comprises a subscriber management component 191 that takes care of subscriber and subscription management. It comprises a category manager 171 that facilitates creation of new category of content and selection of content categories by subscribers, a delivery time manager 173 that facilitates setting and resetting delivery schedules by/for subscribers, and a preferences manager 175 that supports specification of preferences by/for subscribers.

The pre-recorded message that is broadcast to one or more recipients via their mailboxes is one of a pre-recorded audio message and a pre-recorded video message. The voice-mail broadcast management server 113 is associated with a service subscription subscribed to by a plurality of subscribers, each subscriber from the plurality of subscribers being associated with a corresponding one of the plurality of voice-mail boxes, such as voice-mailboxes 157, 159. The pre-recorded messages is one or more of a news, entertainment, motivational, educational, advertisement and public service audible content, public service video content, etc.

The voice-mail broadcast management server 113 delivers the pre-recorded message directly to a user's corresponding one of the plurality of voice-mail boxes 157, without setting up a phone call with the user's mobile device 107 first. The voice-mail broadcast management server 113 forwards the pre-recorded message to more than one of the voice-mail boxes supported by the voice-mail server 151, without establishing a phone connection first with the corresponding mobile devices 107 of the subscribers associated with those voice-mail boxes.

The voice-mail broadcast management server 113 stores a registered mobile phone number for each of the subscribers in the subscriber database 115. One or more categories of content is associated with each of the subscribers, and this is stored in a subscriber's categories component 181 in the subscriber's database 115. In addition, a delivery time window for delivery of messages for each of the subscribers is stored in a delivery time component 189 in the subscriber database 115.

The voice-mail broadcast management server 113 employs one or more categories of content for a subscriber and the delivery time window for the subscriber to identify appropriate messages to be delivered to the subscriber. The voice-mail broadcast management server 113 delivers the appropriate messages to each of the subscribers, i.e. it delivers the appropriate messages to voice-mail boxes associated with or assigned to the subscribers.

In one embodiment, the voice-mail broadcast management server 113 identifies the appropriate messages for each of the subscribers based on the one or more categories of content for each of the subscribers. It then delivers it, employing the registered mobile phone number for each of the subscribers, the delivery scheduled employing the appropriate requested time window for each of the subscribers.

In another embodiment, a service subscription entitles the plurality of subscribers to receive the pre-recorded message of a certain content category (or a set of content categories), wherein the pre-recorded message (audio or video message) is customized to one or more of an identity and an expressed need of the corresponding ones of the plurality of subscribers. The identity is a subscriber account information and the expressed need is a set of preferences including a mobile device type in a related embodiment. The service subscription entitles the plurality of subscribers to receive the pre-recorded message, wherein the same pre-recorded message is delivered to the voice-mail boxes associated with the plurality of subscribers.

In one embodiment, the mobile device 107 comprises a voice-mail client 123 that facilitates retrieval of audio and video messages from a subscriber's voice-mailbox 157 for playing it/rendering it in the mobile device 107.

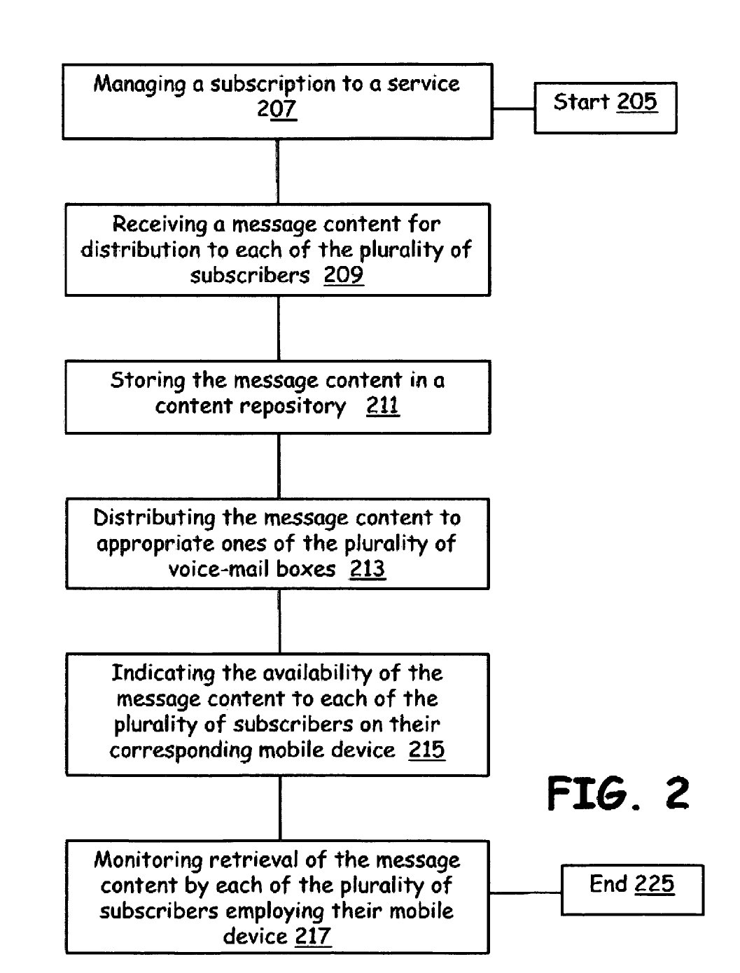

FIG. 2 is a flow chart of an exemplary operation 205 of the voice-mail based message broadcasting system 105. The operation starts at a start block 205 where a content is made ready for distribution and subscribers are identified. Then, at a next block 207, the operation proceeds to managing, by the voice-mail broadcast management server 113, a subscription to a service for a plurality of subscribers. Each of the plurality of subscribers have a mobile device that is identified by a mobile phone number, each of the mobile phone numbers associated with one of a plurality of voice-mail boxes managed by a voice-mail server.

Then, at a next block 209, the operation proceeds to receiving, by the voice-mail broadcast management server 113, a message content for distribution to each of the plurality of subscribers. Message content can be in audio form, in video form, a combination of the two, etc.

Then, at a next block 211, the operation continues with storing, by the voice-mail broadcast management server 113, the message content in the content repository 185. Then, at a next block 213, it transitions to distribution of the message content by the voice-mail broadcast management server 113. The distribution is to an appropriate one of the plurality of voice-mail boxes, or to a plurality of voice-mail boxes, based on the number of subscribers identified as recipients for that category of content.

Later, at a next block 215, the operation continues with indicating the availability of the message content to the subscribers to whom the message content is delivered in their voice-mailbox. A subscriber can see, on their respective mobile devices that a message has been delivered into their respective voice-mailboxes.

Then, at a next block 217, monitoring starts, by the voice-mail broadcast management server 113. The monitoring includes tracking of the retrieval of the message content by each of the plurality of subscribers employing their respective mobile devices. Then, at a next end block 225, the processing terminates.

Thus, the operation implements broadcasting, wherein the same message content is broadcast to the of voice-mail boxes managed by the voice-mail server 151, wherein the message content is a pre-recorded message that is one or more of a news, entertainment, motivational, educational, advertisement, public service audible content and public service video content.

In one embodiment, the distributing operation at the block 213 comprises the steps of identifying a mobile phone number for each of the plurality of subscribers, communicating a voice-mail directly to each of the plurality of subscribers based on their mobile phone number without causing a phone call connection to be established with the corresponding mobile device, and recording the voice-mail at the appropriate one of the plurality of voice-mail boxes for each of the plurality of subscribers. The voice-mail that is provided to the subscriber comprises the message content.

In one embodiment, the step of distributing at the block 213 comprises the steps of identifying, by the voice-mail broadcast management server 113, appropriate messages for each of the plurality of subscribers based on a category of content selection for each of the subscribers, personalizing the appropriate messages, if necessary, and scheduling delivery of the appropriate messages for each of the plurality of subscribers based on requested delivery time, and delivering according to the schedule. Personalizing the messages is typically based on a subscriber identity and a subscriber need associated with the each of the plurality of subscribers. Scheduling delivery is based on requested delivery time that the subscriber has selected previously, or a delivery time assigned to the subscriber. Delivering appropriate messages for each of the plurality of subscribers, by the voice-mail broadcast management server 113, involves interactions between the voice-mail broadcast management server 113 and the voice-mail server 151.

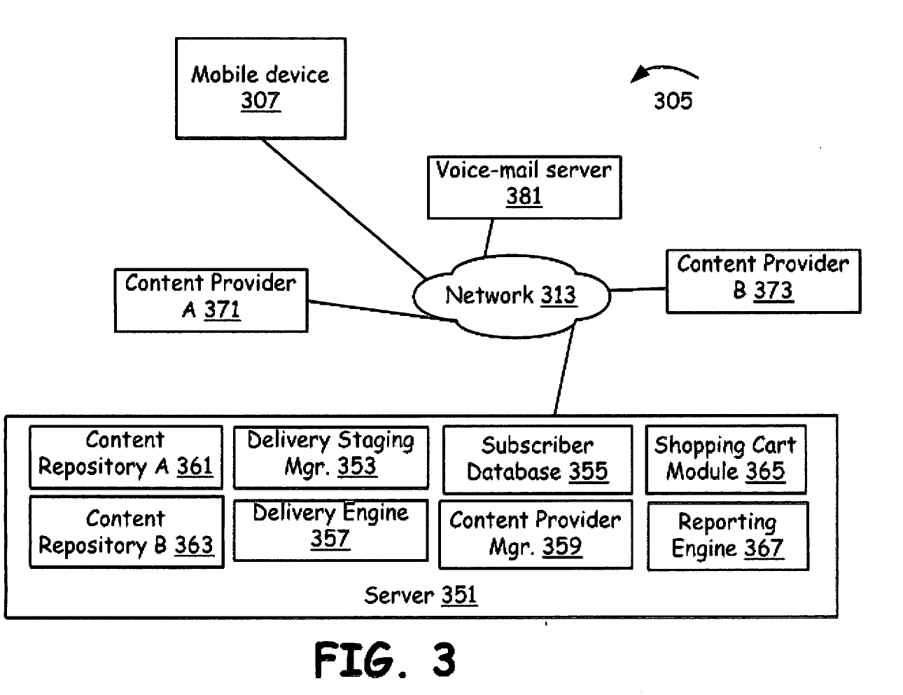

FIG. 3 is a perspective block diagram of an exemplary voice-mail based broadcasting system 305 built in accordance with the present invention, that broadcasts messages, such as audio and video messages, to a plurality of subscribers via their voice-mailbox. The voice-mail based broadcasting system 305 comprises a server 351, a voice-mail server 381, one or more content providers 371, 373, and a mobile device 307 communicatively coupled to the voice-mail server 381. The server 351 comprises one or more content repositories 361, 363 (one for each content provider in general), a delivery staging manager 353, a delivery engine 357, a subscriber database 355, a content provider manager 359, a shopping cart module 365 and a reporting engine 367.

The subscriber database 355 contains subscriber specific information, subscriber preferences, subscriber details, subscriber selections of categories of content, etc. For example, the subscriber database contains subscriber name, email address, phone numbers, credit card information, subscription duration, referral information, content provider references, content category preferences, delivery preferences, delivery time window, and tithing preferences.

Using the voice-mail storage services of the voice-mail server 381, the server 351 conducts broadcast type delivery (one-to-many) of messages, wherein the messages can be audio messages, video messages, etc. The server 351 makes it possible to schedule a time frame for the delivery of content, wherein the schedule is subscriber specific. The broadcast of the messages by the server 351 is automatic and does not require human intervention for the delivery process.

Subscription to different services that provide periodic and frequent messages is supported by the server 351. Using the shopping cart module 365, a subscriber can subscribe to services, such as self-help services that provide periodic motivational messages. The delivery staging manager 353 facilitates staging of content for testing and delivery to subscribers. The delivery engine 357 manages communication of content to the voice-mail server along with subscriber lists, etc. It manages delivery of messages to the voice-mailboxes of subscribers.

The content provider manager 359 manages content upload from one or more content providers 371, 373. The reporting engine 367 makes it possible to track and report the delivery of messages to subscribers, delivery of content by content providers, subscription demand, etc.

The content providers 371, 373 can deliver content, in the form of audible message and video messages, to a list of their subscribers via the server 351. This content is one of the following:
news of specific interest to the subscriber,
health-related reminders,
updates on entertainment stories,
inspirational reminders
jokes
educational clips
public service type announcements that are not time critical can be delivered in this manner
communication from non-profit organizations to their members
promotional material from businesses

In one embodiment, the server 351 is used to broadcast different types of inspirational content (e.g. different scope and/or different author) to subscribers of a service. The subscribers use the webpages provided by the server 351 to subscribe to a service to have their selected content delivered to their mobile device 307 via their voice mail feature. The subscribers provide their cell phone number, an explicit permission to use the cell phone number to have the selected content delivered. The subscriber selects a time frame for delivery, and provides details of a form of payment (such as a credit card account) for the service. Depending on the features of their cellular service provider's voice-mail server 381, the subscribers can save the content on their cell-phone, forward it to another person, download it to a computer for future use, etc.

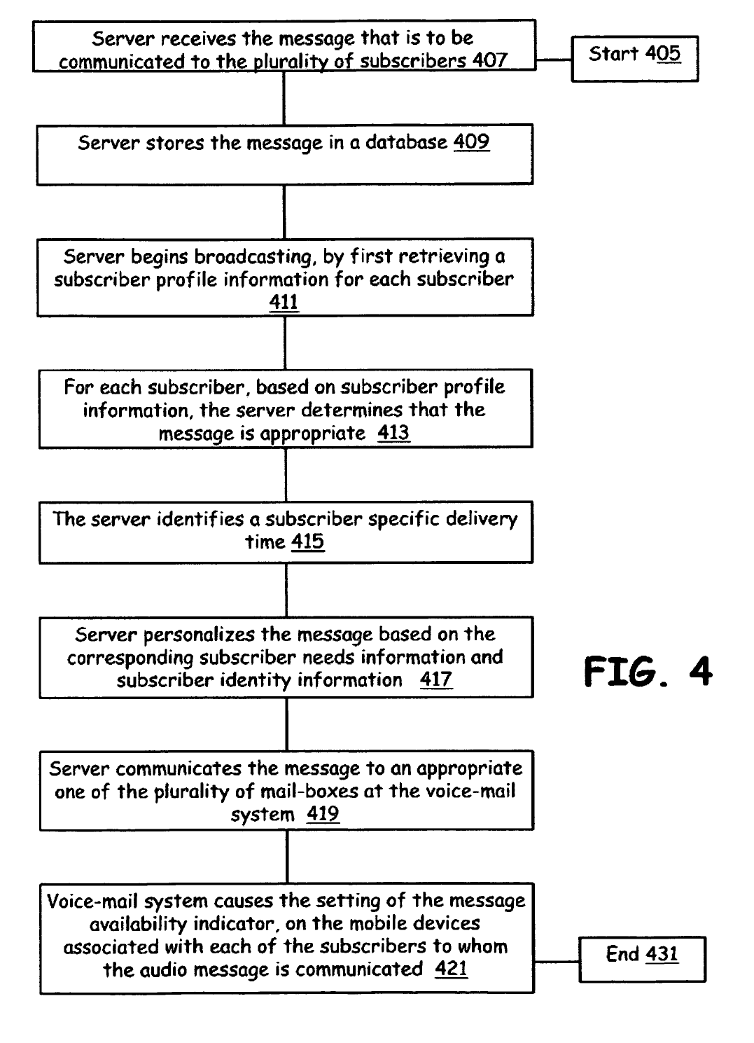

FIG. 4 is a flow chart of an exemplary operation of the voice-mail based broadcasting system that is capable of distributing a message to a plurality of subscribers on their corresponding mobile devices. The operation starts at a start block 405. Then, at a next block 407, the server 351 receives the message that is to be communicated to the plurality of subscribers. Then, at a next block 409, the server 351 stores the message is a database. Then, at a next block 411, the server 351 begins broadcasting the message to the plurality of subscribers via a voice-mail system. It does so by first retrieving a subscriber profile information for each of the plurality of subscribers from the database. The subscriber profile information comprises a subscriber content category selection, a preferred delivery time, a subscriber needs information, a subscriber identity information and subscription details.

At a next block 413, for each of the plurality of subscribers, based on their subscriber profile information, the server determines that the message is appropriate. Then, at a next block 415, the server 351 identifies a subscriber specific delivery time. At a next block 417, the server 351 personalizes the message based on the corresponding subscriber needs information and the subscriber identity information.

Then, at a next block 419, server 351 communicates the message to an appropriate one of the plurality of mail-boxes at the voice-mail system. Later, at a next block 421, the voice-mail system causes the setting of the message availability indicator, on the mobile devices associated with each of the plurality of subscribers to whom the audio message is communicated. Then, the operation terminates at a next end block 431.

The voice-mail system comprises a plurality of mail-boxes, each of the plurality of mail-boxes associated with one of the plurality of subscribers. In general, the message is one of an audio message and a video message and wherein the broadcasting occurs based on a delivery time specified by the plurality of subscribers. Where the message is an audio message, it is associated with one of a plurality of content categories that the user has subscribed to.

In one embodiment, an additional step of saving, by the server 351, a content selection filter, is conducted. Such a content selection filter is specified by each of the plurality of subscribers, and it a subset of a plurality of approved content categories. Thus, an extra step of determining by the server, if the message is appropriate for each of the plurality of subscribers based on their content selection filters, is conducted. In addition, scheduling is conducted by the server, wherein the scheduling of the delivery of the message is based on a preferred delivery time specified by each of the plurality of subscribers.

In one embodiment, the message is communicated directly by the server 351 into a mailbox associated with each of the plurality of subscribers without initiating a phone call with mobile devices associated with the plurality of subscribers. In a related embodiment, the delivery of the message by the server does not require any human intervention and occurs at a time frame that is subscriber specific, wherein the time frame is customized by each of the plurality of subscribers via an appropriate configuration screen provided by the server 351.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A voice-mail based system comprising:
a voice-mail broadcast management server communicatively coupled to a plurality of voice-mail boxes located at a voice-mail server;
a content repository;
a subscriber database;
the voice-mail broadcast management server providing efficient voice-mail distribution to more than one of the plurality of voice-mail boxes employing a content stored in the content repository;
the voice-mail broadcast management server broadcasting a pre-recorded message to the more than one of the plurality of voice-mail boxes, wherein the pre-recorded message is the content retrieved from the content repository; and
the voice-mail broadcast management server tracking a user's access to the pre-recorded message from a corresponding one of the plurality of voice-mail boxes via a user's mobile device.

2. The voice-mail based system of claim 1 wherein the pre-recorded message is one of a pre-recorded audio message and a pre-recorded video message, and wherein the voice-mail broadcast management server is associated with a service subscription subscribed to by a plurality of subscribers, each subscriber from the plurality of subscribers being associated with a corresponding one of the plurality of voice-mail boxes.

3. The voice-mail based system of claim 2 wherein the pre-recorded audio message is one or more of a news, entertainent, motivational, educational, advertisement and public service audible content.

4. The voice-mail based system of claim 2 wherein the voice-mail broadcast management server delivers the pre-recorded message directly to the user's corresponding one of the plurality of voice-mail boxes, without setting up a phone call with the user's mobile device first.

5. The voice-mail based system of claim 2 wherein the voice-mail broadcast management server forwards the pre-recorded message to the more than one of the plurality of voice-mail boxes without establishing a phone connection first with the corresponding mobile devices of the plurality of subscribers associated with the more than one of the plurality of voice-mail boxes.

6. The voice-mail based system of claim 5 wherein the voice-mail broadcast management server comprises:
a registered mobile phone number for each of the plurality of subscribers associated with the more than one of the plurality of voice-mail boxes that is stored in the subscriber database;
one or more categories of content associated with each of the plurality of subscribers associated with the more than one of the plurality of voice-mail boxes, that is stored in the subscriber database;
a time window for delivery of messages for each of the plurality of subscribers, that is stored in the subscriber database;
the voice-mail broadcast management server employing the one or more categories of content and the time window to identify appropriate messages from a plurality of pre-recorded messages available; and
the voice-mail broadcast management server delivering the appropriate messages to the each of the more than one of the plurality of voice-mail boxes.

7. The voice-mail based system of claim 6 wherein the voice-mail broadcast management server identifies the appropriate messages for each of the plurality of subscribers based on the one or more categories of content for each of the plurality of subscribers and delivers it, employing the registered mobile phone number for each of the plurality of subscribers, the delivery scheduled employing the appropriate requested time window for each of the plurality of subscribers.

8. The voice-mail based system of claim 2 wherein the service subscription entitles the plurality of subscribers to receive the pre-recorded message, wherein the pre-recorded audio message is customized based on one or more of a subscriber identity and an expressed need of the corresponding ones of the plurality of subscribers.

9. The voice-mail based system of claim 2 wherein the service subscription entitles the plurality of subscribers to receive the pre-recorded message, wherein the same pre-recorded message is delivered to the voice-mail boxes associated with the plurality of subscribers.

10. A method of operating a voice-mail based system that delivers voice-mail, the method comprising:
managing, by a voice-mail broadcast management server, a subscription to a service for a plurality of subscribers, each of the plurality of subscribers having a mobile device that is identified by a mobile phone number, each of the mobile phone numbers associated with one of a plurality of voice-mail boxes managed by a voice-mail server;
receiving, by the voice-mail broadcast management server, a message content for distribution to each of the plurality of subscribers;
storing, by the voice-mail broadcast management server, the message content in a content repository;
distributing, by the voice-mail broadcast management server, the message content to an appropriate one of the plurality of voice-mail boxes; and
monitoring, by the voice-mail broadcast management server, retrieval of the message content by each of the plurality of subscribers employing their mobile device.

11. The method of claim 10 wherein the service comprises broadcasting the message content to the of voice-mail boxes managed by a voice-mail server, wherein the message content is a pre-recorded message that is one or more of a news, entertainment, motivational, educational, advertisement, public service audible content and public service video content.

12. The method of claim 10 wherein the distributing comprises:
identifing a mobile phone number for each of the plurality of subscribers;
communicating a voice-mail directly to each of the plurality of subscribers based on their mobile phone number without causing a phone call connection to be established with the corresponding mobile device, wherein the voice-mail comprises the message content; and
recording the voice-mail at the appropriate one of the plurality of voice-mail boxes for each of the plurality of subscribers.

13. The method of claim 10 wherein the distributing further comprises:
indicating the availability of the message content to each of the plurality of subscribers on their corresponding mobile device.

14. The method of claim 10 wherein the distributing comprises:
identifing, by the voice-mail broadcast management server, appropriate messages for each of the plurality of subscribers based on a category of content selection for each of the subscribers;
personalizing the appropriate messages, if necessary, based on an identity and a subscriber need associated with the each of the plurality of subscribers;
scheduling delivery of the appropriate messages for each of the plurality of subscribers based on requested delivery time; and
delivering appropriate messages for each of the plurality of subscribers, by the voice-mail broadcast management server, at the scheduled requested time window.

15. A method of distributing a message to a plurality of subscribers on their corresponding mobile devices, the method comprising:
receiving, by a server, the message that is to be communicated to the plurality of subscribers;
storing, by the server in a database, the message; and
broadcasting, by the server, the message to the plurality of subscribers via a voice-mail system, wherein the voice-mail system comprises a plurality of mail-boxes, each of the plurality of mail-boxes associated with one of the plurality of subscribers.

16. The method of distributing the message of claim 15 wherein the message is one of an audio message and a video message and wherein the broadcasting occurs based on a delivery time specified by the plurality of subscribers.

17. The method of distributing a message of claim 16 wherein broadcasting comprises:
retrieving, by the server, a subscriber profile information for each of the plurality of subscribers from the database, wherein the subscriber profile information comprises a subscriber content category selection, a preferred delivery time, a subscriber needs information, a subscriber identity information and subscription details; and
for each of the plurality of subscribers, based on their subscriber profile information:
determining that the message is appropriate;
identifying a subscriber specific delivery time;
personalizing the message based on the corresponding subscriber needs information and the subscriber identity information;
communicating the message to an appropriate one of the plurality of mail-boxes at the voice-mail system; and
indicating, on the mobile devices associated with each of the plurality of subscribers to whom the audio message is communicated, a message availability indicator.

18. The method of distributing a message of claim 16 wherein the audio message is associated with one of a plurality of content categories the method further comprising:
saving, by the server, a content selection filter, specified by each of the plurality of subscribers, wherein the content selection filter is a subset of a plurality of approved content categories;
determining by the server, if the message is appropriate for each of the plurality of subscribers based on their content selection filters; and
scheduling by the server, delivery of the message based on a preferred delivery time specified by each of the plurality of subscribers.

19. The method of distributing a message of claim 16 wherein the message is communicated directly by the server into a mailbox associated with each of the plurality of subscribers without initiating a phone call with mobile devices associated with the plurality of subscribers.

20. The method of distributing a message of claim 16 wherein the delivery of the message by the server does not require any human intervention and occurs at a time frame that is subscriber specific, wherein the time frame is customized by each of the plurality of subscribers via an appropriate configuration screen provided by the server.
